(19) United States
(12) Patent Application Publication
(10) Pub. No.: US 2015/0206345 A1
(43) Pub. Date: Jul. 23, 2015

(54) APPARATUS, SYSTEM, AND METHOD FOR GENERATING THREE-DIMENSIONAL MODELS OF OBJECTS

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); ZONG-TAO YANG, Shenzhen (CN)

(21) Appl. No.: 14/597,628

(22) Filed: Jan. 15, 2015

(30) Foreign Application Priority Data
Jan. 20, 2014 (CN) 201410025885.0

(51) Int. Cl. G06T 17/20; G06T 19/20

(52) U.S. Cl. CPC G06T 17/20; G06T 19/20; G06T 2200/08; G06T 2219/2004; G06T 2219/2016

(57) ABSTRACT

In a three-dimensional image models generating method, a two-dimensional point cloud model and a two-dimensional image of an object are acquired and aligned. A triangular mesh surface of the point cloud model is constructed and each triangle in the triangular mesh surface is assigned with an identifier. The image is divided into a plurality of triangles according to the triangle in the triangular mesh surface, and each triangle in the image is correspondingly assigned with an identifier. The triangular mesh surface is converted from a two-dimensional point cloud model to a three-dimensional point cloud model. After adjusting sizes of the triangle of the image, each triangle of the image is pasted onto a corresponding triangle of the three-dimensional point cloud model according to the identifiers, to generate a three-dimensional image model.

### CROSS-REFERENCE TO RELTATED APPLICATIONS

This application claims priority to Chinese Patent Application No. 201410025885.0 filed on Jan. 20, 2014, in the China Intellectual Property Office, the contents of which are incorporated by reference herein.

### FIELD

The subject matter herein generally relates to a point cloud data processing system and method, and more specifically relates to an apparatus, a method and a system of generating a three-dimensional image model of an object using two-dimensional point cloud model of the object.

### BACKGROUND

Point cloud models may be created by a scanner. The scanner measures a large number of points on an object's surface, and outputs a point cloud model as a data file. The point cloud model can be used to create a three-dimensional (3D) computer aided design (CAD) model for manufactured parts of the object. However, details of the object, such as colors, textures, and patterns, are not shown in the 3D CAD model created by the point cloud model.

### BRIEF DESCRIPTION OF THE DRAWINGS

Implementations of the present technology will be described, by way of example only, with reference to the attached figures.

FIG. 1 is a block diagram of one embodiment of a hardware environment for executing a three-dimensional image models generation system.

FIG. 2 is a block diagram of one embodiment of function modules of the three-dimensional image models generation system in FIG. 1.

FIG. 3 is a flowchart of one embodiment of a three-dimensional image models generating method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

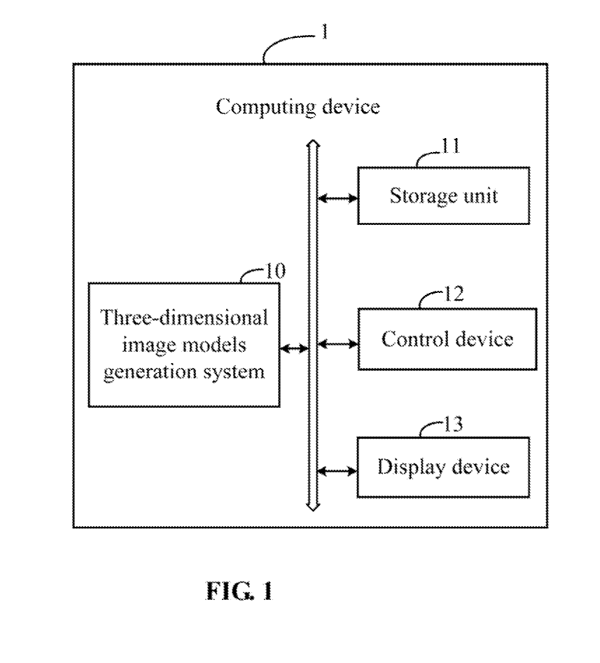

FIG. 1 is a block diagram of one embodiment of a hardware environment for executing a three-dimensional image models generation system 10. The three-dimensional image models generation system 10 is installed and runs in an apparatus, for example, a computing device 1. The computing device 1 can include a storage unit 11, a control unit 12, and a display unit 13.

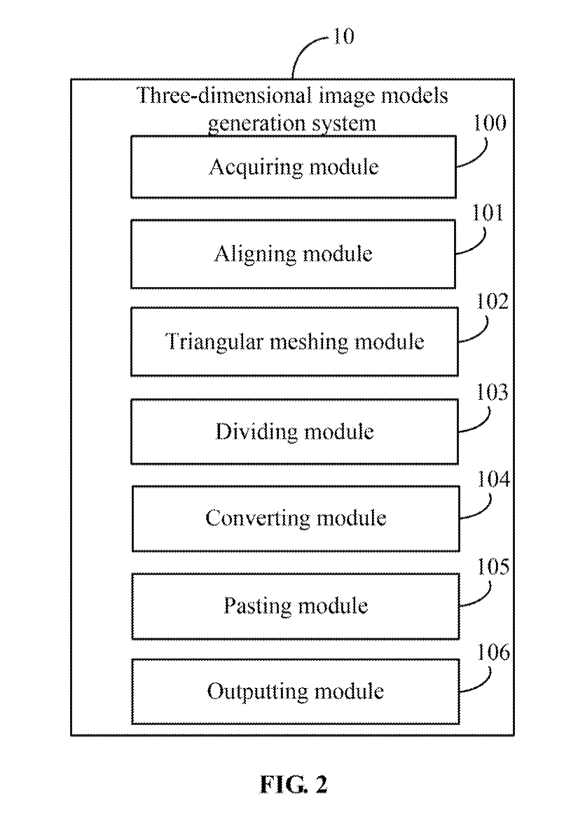

The three-dimensional image models generation system 10 can include a plurality of function modules (shown in FIG. 2) that generates a three-dimensional image model of an object using a two-dimensional point cloud model of the object.

The storage unit 11 can include some type(s) of non-transitory computer-readable storage medium, for example a hard disk drive, a compact disc, a digital video disc, or tape drive. The storage unit 11 stores computerized codes of the function modules of the three-dimensional image models generation system 10.

The control unit 12 can be a processor, an application-specific integrated circuit (ASIC), or a field programmable gate array (FPGA), for example. The control device 12 can execute the computerized codes of the function modules of the three-dimensional image models generation system 10 to realize the functions of the three-dimensional image models generation system 10.

FIG. 2 is a block diagram of one embodiment of the function modules of the three-dimensional image models generation system 10. The function modules can include an acquiring module 100, an aligning module 101, a triangle meshing module 102, a dividing module 103, a converting module 104, a pasting module 105, and an output module 106.

The acquiring module 100 can acquire a two-dimensional (2D) point cloud model (hereinafter “point cloud model”) of an object, and further acquire a 2D image (hereinafter “image”) of the object. In one embodiment, the point cloud model can be created by a scanner which communicates with the computing device 1. The scanner measures a large number of points on an object's surface. The points are defined by X and Y coordinates based on a coordinate system, and intended to represent the external surface of the object. The point cloud model represented by the X and Y coordinates are stored into the storage unit 11 of the computing device 1. The image of the object can be captured by an image device, such as a charge coupled device (CCD), and then stored into the storage unit 11. The acquiring module 100 can acquire the point cloud model and the image from the storage unit 11.

The aligning module 101 can align the point cloud model and the image. In one embodiment, the aligning module 101 aligns the point cloud model and the image by superposing the image and the point cloud model. The image and the point cloud model can be superposed by adjusting sizes of the image, and executing translational movements and rotating movements in a same coordinate system.

The triangle meshing module 102 can construct a triangular mesh surface of the point cloud model and assign a unique identifier (ID) to each triangle in the triangular mesh surface. In one embodiment, the triangle meshing module 102 constructs the triangular mesh surface using the following method: selecting a point of the point cloud model as a first point, computing a second point which is nearest to the first point in the point cloud model; and locating a third point in the point cloud model to construct a triangle whose circumcircle includes no points of the point cloud model. After all points in the point cloud model have been selected to construct a triangle, the triangular mesh surface is generated.

The dividing module 103 can divide the image into a plurality of triangles according to each triangle in the triangular mesh surface, and assign an ID to each triangle in the image correspondingly. As mentioned above, the image and the point cloud model are in the same coordinate system, the dividing module 103 divides the image according to coordinates of vertexes of the triangle in the triangular mesh surface.

The converting module 104 can convert the triangular mesh surface from a 2D point cloud model to a 3D point cloud model.

The pasting module 105 can adjust sizes of the triangle of the image, paste each triangle of the image onto a corresponding triangle of the 3D point cloud model according to the IDs of the triangles in the image and the triangles in the triangular mesh surface, and generate a 3D image model. The 3D image model includes the image of the object, thus, details of the object, such as colors, textures, and patterns, can be shown.

The output module 106 can output the 3D image model. In one embodiment, the 3D image model can be displayed on the display unit 13 of the computing device 1.

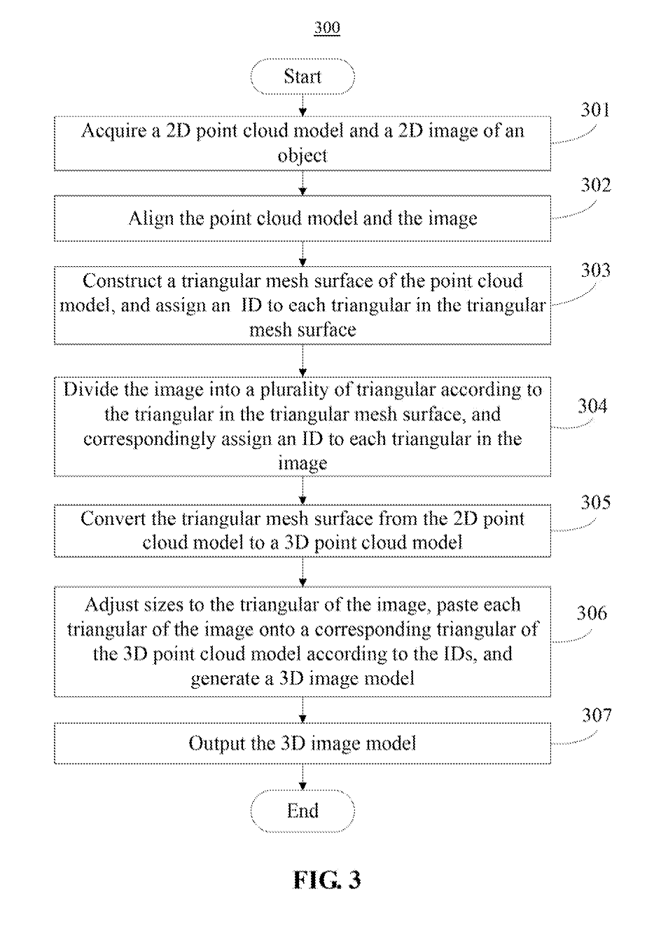

FIG. 3 is a flowchart of one embodiment of a three-dimensional image models generating method.

Referring to FIG. 3, a flowchart is presented in accordance with an example embodiment illustrated. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the exemplary method 300. Furthermore, the illustrated order of blocks is by example only and the order of the blocks can change according to the present disclosure. Additional blocks may be added or fewer blocks may be utilized, without departing from this disclosure. The exemplary method 300 can begin at block 301.

At block 301, an acquiring module acquires a 2D point cloud model (hereinafter “point cloud model”) of an object and further acquires a 2D image (hereinafter “image”) of the object. The acquiring module 100 can acquire the point cloud model and the image from a storage unit of a computing device.

At block 302, the aligning module aligns the point cloud model and the image in one coordinate system. In one embodiment, the aligning module aligns the point cloud model and the image by superposing the image and the point cloud model by adjusting sizes of the image, and executing translational movements and rotating movements in the coordinate system.

At block 303, the triangle meshing module constructs a triangular mesh surface of the point cloud model and assigns an ID to each triangle in the triangular mesh surface. In one embodiment, the triangle meshing module constructs the triangular mesh surface using the following method: selecting a point of the point cloud model as a first point, computing a second point which is nearest to the first point in the point cloud model; and locating a third point in the point cloud model to construct a triangle whose circumcircle contains no point of the point cloud model. After all points in the point cloud model have been selected to construct a triangle, the triangular mesh surface is generated.

At block 304, the dividing module divides the image into a plurality of triangles according to each triangle in the triangular mesh surface, and correspondingly assigns an ID to each triangle in the image. As mentioned above, the image and the point cloud model are in the same coordinate system, the dividing module divides the image according to coordinates of vertexes of the triangle in the triangular mesh surface.

At block 305, the converting module converts the triangular mesh surface from a 2D point cloud model to a 3D point cloud model.

At block 306, the pasting module adjusts sizes of the triangle of the image, pastes each triangle of the image onto a corresponding triangle of the 3D point cloud model according to the IDs, and generates a 3D image model. The 3D image model includes the image of the object, thus, details of the object, such as colors, textures, and patterns, can be shown.

At block 307, the output module outputs the 3D image model. In one embodiment, the 3D image model can be displayed on the display unit 13 of the computing device 1.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for generating three-dimensional image models executable by at least one processor of a computing device, the method comprising:
acquiring a two-dimensional point cloud model of an object and a two-dimensional image of the object;
aligning the point cloud model and the image in a coordinate system;
constructing a triangular mesh surface of the point cloud model and assigning a unique identifier to each triangle in the triangular mesh surface;
dividing the image into a plurality of triangles according to each triangle in the triangular mesh surface, and assigning a unique identifier to each of the triangles in the image, each of the identifiers in the image corresponding to a unique identifier in the triangular mesh surface;
converting the triangular mesh surface from a two-dimensional point cloud model to a three-dimensional point cloud model;
pasting each of the plurality of triangles of the image onto a corresponding triangle of the three-dimensional point cloud model according to the identifiers of the triangles in the image and the triangles in the triangular mesh surface, and generating a three-dimensional image model; and
displaying the three-dimensional image model on a display unit of the computing device.

2. The method according to claim 1, wherein the point cloud model is created by a scanner communicating with the computing device.

3. The method according to claim 2, wherein the scanner measures a large number of points on a surface of the object to generate the point cloud model, and stores the point cloud model into a storage unit of the computing device.

4. The method according to claim 1, wherein the point cloud model and the image are aligned by:
superposing the image and the point cloud model by adjusting sizes of the image, and executing translational movements and rotating movements in the coordinate system.

5. The method according to claim 1, wherein the triangular mesh surface is constructed by:
selecting a point of the point cloud model as a first point;
computing a second point which is nearest to the first point in the point cloud model; and
locating a third point in the point cloud model to construct a triangle whose circumcircle comprises no point of the point cloud model.

6. The method according to claim 1, wherein the image is divided according to coordinates of vertexes of the triangle in the triangular mesh surface.

7. An apparatus, comprising:
a display unit;
a control unit; and
a storage unit storing one or more programs which, when executed by the control device, causes the control device to:
acquire a two-dimensional point cloud model of an object and a two-dimensional image of the object;
align the point cloud model and the image in a coordinate system;
construct a triangular mesh surface of the point cloud model and assign a unique identifier to each triangle in the triangular mesh surface;
divide the image into a plurality of triangles according to each triangle in the triangular mesh surface, and assign a unique identifier to each of the triangles in the image, each of the identifiers in the image corresponding to a unique identifier in the triangular mesh surface;
convert the triangular mesh surface from a two-dimensional point cloud model to a three-dimensional point cloud model;
pasting each of the plurality of triangles of the image onto a corresponding triangle of the three-dimensional point cloud model according to the identifiers of the triangles in the image and the triangles in the triangular mesh surface, and generate a three-dimensional image model; and
display the three-dimensional image model on the display unit.

8. The apparatus according to claim 7, wherein the point cloud model is created by a scanner communicating with the computing device.

9. The apparatus according to claim 8, wherein the scanner measures a large number of points on a surface of the object to generate the point cloud model, and stores the point cloud model into a storage unit of the computing device.

10. The apparatus according to claim 7, wherein the point cloud model and the image are aligned by:
superposing the image and the point cloud model by adjusting sizes of the image, and executing translational movements and rotating movements in one coordinate system.

11. The apparatus according to claim 7, wherein the triangular mesh surface is constructed by:
selecting a point of the point cloud model as a first point;
computing a second point which is nearest to the first point in the point cloud model; and
locating a third point in the point cloud model to construct a triangle whose circumcircle comprises no point of the point cloud model.

12. The apparatus according to claim 7, wherein the image is divided according to coordinates of vertexes of the triangle in the triangular mesh surface.

13. A non-transitory storage medium having stored thereon instructions that, when executed by a processor of a computing device, causes the processor to perform a three-dimensional image models generating method, the method comprising:
acquiring a two-dimensional point cloud model of an object and a two-dimensional image of the object;
aligning the point cloud model and the image in a coordinate system;
constructing a triangular mesh surface of the point cloud model and assigning a unique identifier to each triangle in the triangular mesh surface;
dividing the image into a plurality of triangles according to each triangle in the triangular mesh surface, and assigning a unique identifier to each of the triangles in the image, each of the identifiers in the image corresponding to a unique identifier in the triangular mesh surface;
converting the triangular mesh surface from a two-dimensional point cloud model to a three-dimensional point cloud model;
adjusting sizes of each of the plurality of triangles of the image, pasting each of the plurality of triangles of the image onto a corresponding triangle of the three-dimensional point cloud model according to the identifiers of the triangles in the image and the triangles in the triangular mesh surface, and generating a three-dimensional image model; and
displaying the three-dimensional image model on a display unit of the computing device.

14. The non-transitory storage medium according to claim 13, wherein the point cloud model is created by a scanner which communicates with the computing device.

15. The non-transitory storage medium according to claim 14, wherein the scanner measures a large number of points on a surface of the object to generate the point cloud model, and stores the point cloud model into a storage unit of the computing device.

16. The non-transitory storage medium according to claim 13, wherein the point cloud model and the image are aligned by:
superposing the image and the point cloud model by adjusting sizes of the image, and executing translational movements and rotating movements in one coordinate system.

17. The non-transitory storage medium according to claim 13, wherein the triangular mesh surface is constructed by:
selecting a point of the point cloud model as a first point;
computing a second point which is nearest to the first point in the point cloud model; and
locating a third point in the point cloud model to construct a triangle whose circumcircle comprises no point of the point cloud model.

18. The non-transitory storage medium according to claim 13, wherein the image is divided according to coordinates of vertexes of the triangle in the triangular mesh surface.
